(19) United States
(12) Patent Application Publication
(10) Pub. No.: US 2010/0031825 A1
(43) Pub. Date: Feb. 11, 2010

(54) Blending System

(76) Inventor: David M. Kemp, Powder Springs, GA (US)

Correspondence Address: BOYLE FREDRICKSON S.C., 840 North Plankinton Avenue, MILWAUKEE, WI, 53203, US

(21) Appl. No.: 12/536,131

(22) Filed: Aug. 5, 2009

Related U.S. Application Data
(60) Provisional application No. 61/086,360, filed on Aug. 5, 2008.

(51) Int. Cl. A47J 31/00; G05D 11/02; B01F 5/04; B01F 3/04

(52) U.S. Cl. 99/275; 366/152.3; 366/152.2; 261/76; 99/536

(57) ABSTRACT

A blending system includes a first liquid supply arrangement for providing a first liquid component, a second liquid supply arrangement for providing a second liquid component, a mixing arrangement for mixing the first and the second liquid components to form a blending liquid, and a mass flow measuring device for determining the mass flow of the blended liquid at a location downstream of the mixing arrangement. The blending system further includes a control arrangement for controlling the first and the second liquid supply arrangements in response to the mass flow measuring device. The mass flow measuring device may also measure the density and/or volumetric flow of the mixed liquid. The blending system may also be setup without a holding tank.

### CROSS-REFERENCE TO RELATED APPLICATION

The present application claims the benefit of U.S. Ser. No. 61/086,360, filed Aug. 5, 2008.

### BACKGROUND AND SUMMARY OF THE INVENTION

This invention relates generally to liquid blending and, more particularly, to a liquid blending system that provides precisely controlled dispensing of the liquid components to attain a blended liquid having desired characteristics.

In fluid blending systems, such as are used in the food and beverage industry, it has been known to route the flow of each liquid component through a mass flow meter in order to blend the components together in a desired ratio. The ratio of the final, blended product is then tested in an out-of-line sampling process at a location far downstream of the location at which the blending operation takes place. While a system such as this is functional, it is subject to error and waste. For example, if the ratio of the final, blended product is outside of specifications, this will not be discovered until a significant amount of blended product has been produced, and all of the out-of-specification product must then be discarded.

Additionally, conventional blending systems, especially those used to blend syrup and water, typically have a storage tank that holds chilled carbonated mixed fluid for subsequent delivery to a filler system that fills individual containers with the mixed fluid. The addition of the storage tank greatly increases the overall size of the blending system and the storage tank must be regularly cleaned. Thus, a blending system setup without such a holding tank would be advantageously smaller, would reduce product inventory and would require less sanitation time.

The present invention involves the use of dispensing equipment that can carefully and precisely control dispensing of the liquid components, in combination with a flow meter that ascertains certain characteristics of the blended product immediately after the liquid components are blended together. In one embodiment, the invention is incorporated into a holding tank-less blending system used to mix syrup and water.

In accordance with one aspect of the invention, a blending system includes a first liquid supply arrangement for providing a first liquid component, a second liquid supply arrangement for providing a second liquid component, a mixing arrangement for mixing the first and the second liquid components to form a blending liquid, and a mass flow measuring device for determining the mass flow of the blended liquid at a location downstream of the mixing arrangement. The blending system further includes a control arrangement for controlling the first and the second liquid supply arrangements in response to the mass flow measuring device.

In accordance with another aspect of the invention, a blending system includes a first liquid supply arrangement for providing a first liquid component, a first volumetric flow determining device for determining the volumetric flow of the first liquid component, a second liquid supply arrangement for providing a second liquid component, and a second volumetric flow determining device for determining the volumetric flow of the second liquid component. The blending system further includes a mixing arrangement for mixing the first and the second liquid components, a density measuring device for measuring the density of the mixed liquid at a location downstream of the mixing arrangement, and a control arrangement for controlling the first and the second liquid supply arrangements in response to the density measuring device.

According to another aspect of the invention, a blending system is provided having first and second liquid supply arrangements that provide first and second liquid components, respectively. The blending system also has mixing arrangement for mixing the first and the second liquid components to form a mixed or blending liquid. A density measuring device is provided for determining the density of the blending liquid at a location downstream of the mixing arrangement, and a control arrangement is provided for controlling the first and the second liquid supply arrangements in response to the density measuring device.

Other objects, features, aspects, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout.

In the drawings:

FIG. 1 is a schematic diagram of a blending system in a general application according to one embodiment of the invention;

FIG. 2 is a schematic diagram of a blending system used to produce a product such as a soft drink that is formed of blended water and syrup according to another embodiment of the invention;

FIG. 3 is a schematic diagram of a tank-free blending system to produce a product such as a soft drink that is formed of blended water and syrup according to another embodiment of the invention; and

FIG. 4 illustrates an alternative embodiment of a liquid mixing or blending system in accordance with the present invention.

### DETAILED DESCRIPTION OF THE INVENTION

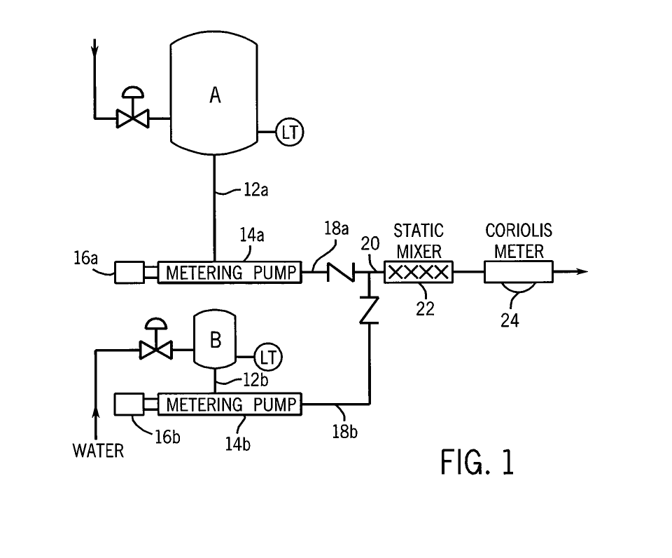

FIG. 1 provides a general illustration of the present invention, which can be used in a variety of applications. As shown in FIG. 1, a first liquid component is supplied from a source A, which may be a tank or reservoir (or alternatively may simply be a pipe that supplies the liquid component), and a second liquid component is supplied from a source B, which again may be a tank or reservoir (or alternatively may simply be a pipe that supplies the liquid component). The two liquid components are destined to be mixed or blended together to form a final, blended product.

From source A, the first liquid component is supplied through a line 12a to a metering pump 14a, which is driven by a motor 16a. Similarly, the second liquid component is supplied through a line 12b to a metering pump 14b, which is driven by a motor 16b. The metering pumps 14a, 14b function to accurately dispense desired quantities of the first and second liquid components according to a predetermined ratio. Representatively, the metering pumps 14a, 14b may be progressive cavity metering pumps, such as are available from any number of known manufacturers. The motors 16a, 16b that drive respective metering pumps 14a, 14b are preferably variable speed motors, e.g. servo-type motors. In a manner as is known, motors of this type can be carefully controlled so that the speed of operation can be constantly and almost instantaneously changed as desired, in response to input signals provided by a motor controller. In this manner, the operation of the metering pumps 14a, 14b can likewise be carefully controlled so that the output of each pump can be constantly and almost instantaneously varied as desired.

Metering pump 14a discharges to a line 18a, and metering pump 14b discharges to a line 18b. The lines 18a and 18b connect together, so that the two liquid components are supplied to a line 20. A mixer 22 is in line 20, and functions to mix or blend the two liquid components together as the liquid components are moved through line 20. The mixed or blended liquid then passes through a mass flow meter 24 that is in line 20 downstream of mixer 22. In a manner as is known, the mass flow meter 24 may be a coriolis-type flow meter.

With the configuration as shown in FIG. 1 and described above, certain characteristics or parameters of the mixed or blended liquid can be measured by the mass flow meter 24 at a point immediately downstream of the location at which the liquid components are mixed together, and then compared to predetermined characteristics or parameters. In the event the measured characteristics or parameters are determined to be outside of acceptable ranges, a controller responsive to inputs from the mass flow meter 24 can adjust the speed of operation of motor 16a and/or motor 16b to alter the supply of one or both of the liquid components from pump 14a and/or pump 14b, to quickly bring the measured characteristics or parameters of the blended liquid within acceptable ranges.

The coriolis-type mass flow meter 24 functions to measure the volumetric flow, mass flow and density of the mixed or blended liquid. The flow volume is known from the output of the pumps 14a and 14b, and the density of the mixed or blended liquid can be determined using the mass flow meter data. Many typical applications require that the liquid density fall within an acceptable range, and the present invention allows precise and nearly instantaneous control of this important parameter.

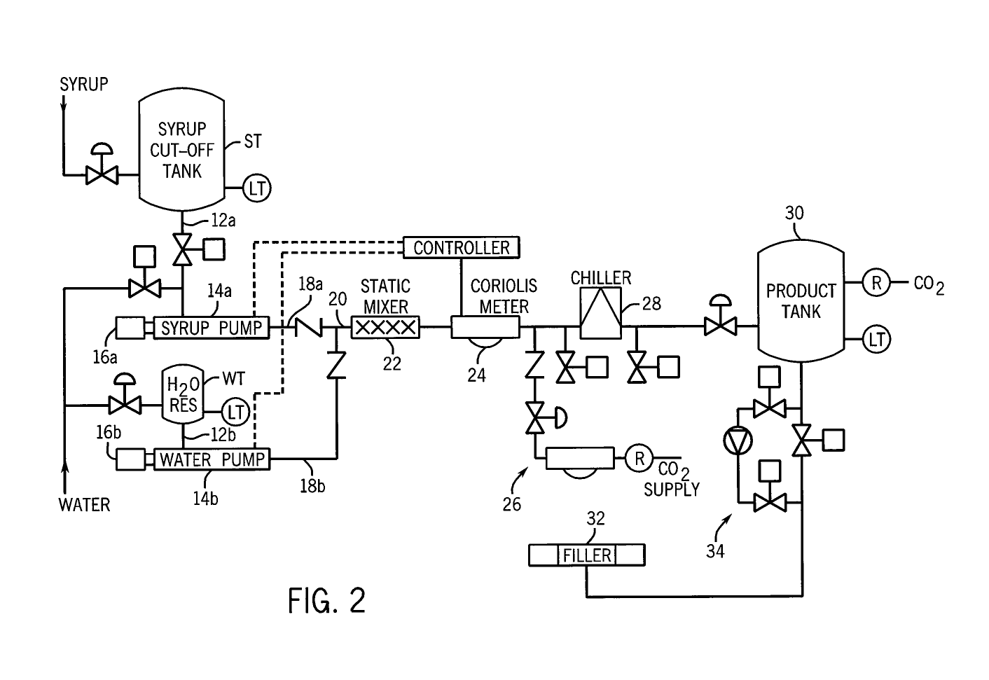

FIG. 2 illustrates a representative application of the system shown in FIG. 1. In this application, the blending system is used to produce a product such as a soft drink that is formed of blended water and syrup. It should be understood that the application illustrated in FIG. 2 is representative of any number of different applications in which the system of FIG. 1 may be used to blend two or more liquids together to provide a blended liquid having certain predetermined characteristics.

In the representative system shown in FIG. 2, the first liquid A is in the form of syrup that may be supplied from a syrup tank ST to pump 14a. The second liquid B is in the form of water that may be supplied from a water tank WT to pump 14b. The syrup and water streams are supplied through lines 18a and 18b, respectively, to line 20 and to mixer 22, and then to mass flow meter 24. The flow meter 24 functions to measure the volumetric flow, mass flow and density of the mixed syrup and water, to ensure that the ratio of syrup to water in the mixed stream is within an acceptable range. In this manner, adjustments can quickly be made in the flow rate of either the syrup or the water in the event there are variations in the density (concentration) of the syrup, so that the density (concentration) of the final product is relatively constant.

As also shown in FIG. 2, carbon dioxide may be injected into the mixed syrup and water at a location downstream of flow meter 24 using a conventional carbon dioxide supply system shown generally at 26. The carbonated liquid is then passed through a conventional chiller 28 and is supplied to a pressurized product holding tank 30. In a manner as is known, the carbonated liquid is then supplied to a filler 32 which functions to dispense the liquid into individual containers. An auxiliary booster pump and valve system 34 may be located between the holding tank 30 and the filler 32 in order to maintain a desired degree of pressure on the carbonated liquid during the filling operation.

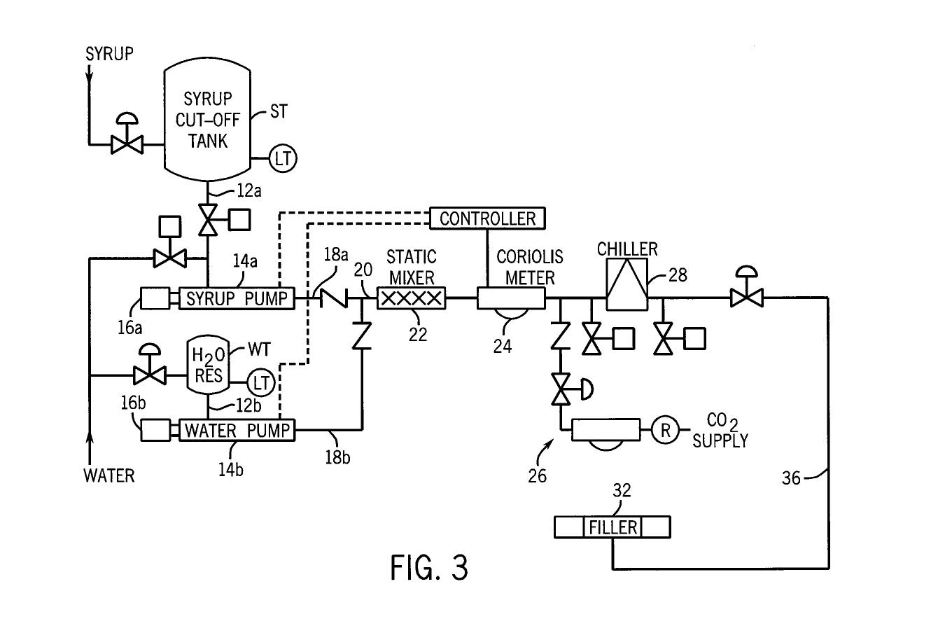

FIG. 3 illustrates a system similar to that shown in FIG. 2, which may be used for production of a mixed or blended liquid such as a carbonated beverage. As in the system shown in FIG. 2, the blending system is used to blend a product such as a soft drink using a first liquid A in the form of syrup that may be supplied from a syrup tank ST to pump 14a, and a second liquid B in the form of water that may be supplied from a water tank WT to pump 14b. The syrup and water streams are supplied through lines 18a and 18b, respectively, to line 20 and to mixer 22, and then to mass flow meter 24. As before, the flow meter 24 functions to measure the volumetric flow, mass flow and density of the mixed syrup and water, to ensure that the ratio of syrup to water in the mixed stream is within an acceptable range. Again, adjustments can quickly be made in the flow rate of either the syrup or the water in the event there are variations in the density (concentration) of the syrup, so that the density (concentration) of the final product is relatively constant.

As in the system shown in FIG. 2, carbon dioxide may be injected into the mixed syrup and water at a location downstream of flow meter 24 using the carbon dioxide supply system 26. The carbonated liquid is then passed through a conventional chiller 28. In the system of FIG. 3, however, the product holding tank 30 of FIG. 2 is eliminated, and instead the pressurized carbonated liquid is supplied directly to filler 32 from the chiller 28. In this system, it is possible to maintain pressure from the injection of carbon dioxide in the lines, including the line 36 between the chiller 28 and the filler 32 as well as the upstream lines including line 20 and lines 18a, 18b, due to the metering pumps 14a, 14b. In this regard, the metering pumps 14a, 14b serve to isolate the respective streams of liquids A and B from the respective tanks ST and WT upstream of respective metering pumps 14a, 14b. This elimination of the product holding tank 30 reduces cleaning time, and saves the space and cost associated with prior art blending and packaging lines.

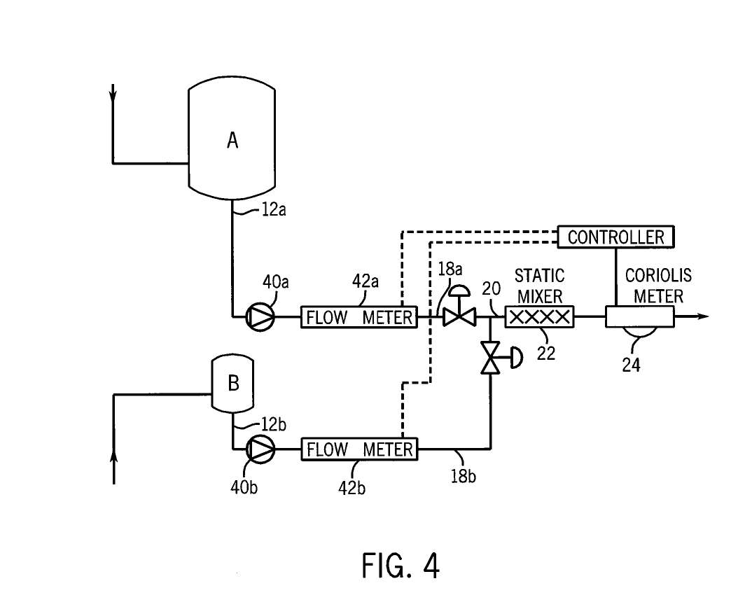

FIG. 4 illustrates an alternative embodiment of a liquid mixing or blending system in accordance with the present invention. In this embodiment, a first liquid component is supplied from source A, which may be a tank or reservoir (or alternatively may simply be a pipe that supplies the liquid component), and a second liquid component is supplied from source B, which again may be a tank or reservoir (or alternatively may simply be a pipe that supplies the liquid component). The two liquid components are destined to be mixed or blended together to form a final, blended product.

From source A, the first liquid component is supplied through a line 12a to a pump 40a, which may be any satisfactory conventional pump such as a centrifugal pump, positive displacement pump, etc. A flow meter 42a is located downstream of pump 40a, and a flow meter 42b is located downstream of pump 40b. Flow meters 42a and 42b function to accurately measure the output of respective pumps 40a, 40b at a location immediately adjacent the outlet of each pump. In this manner, the flow rates of liquids A and B can be carefully controlled before the liquids A and B are mixed together. As in the embodiment of FIG. 1, the lines 18a and 18b connect together, so that the two liquid components A and B are supplied to line 20. The mixer 22 functions to mix or blend the two liquid components together as the liquid components are moved through line 20. The mixed or blended liquid then passes through the mass flow meter 24 downstream of mixer 22. With the configuration as shown in FIG. 4 and described above, the characteristics or parameters of the mixed or blended liquid are measured by the mass flow meter 24 immediately downstream of the location at which the liquid components are mixed together, and then compared to predetermined characteristics or parameters. In the event the measured characteristics or parameters are determined to be outside of acceptable ranges, a controller responsive to inputs from the mass flow meter 24 can adjust the supply of one or both of the liquid components, to quickly bring the measured characteristics or parameters of the liquid within acceptable ranges.

It is understood that the coriolis-type flow meter 24 as shown and described is a mass flow meter, which determines volumetric flow, mass flow as well as density. It is also contemplated that the present invention may be carried out using separate meters that measure flow and density.

While the present invention has been shown and described in connection with the measurement of mass flow and density for compliance with a desired ratio, it is also contemplated that any other parameter of the mixed product can be measured for compliance and that the supply of the liquid components can then be adjusted according to the measured parameter. For example, it is contemplated that parameters such as the color, pH, light absorption, light reflectivity, etc. of the mixed product may be measured and that the supply streams can be adjusted according to such measurements. It is understood that these parameters or characteristics are illustrative of those that can be used to measure compliance with specifications or desired ratios, and that other parameters or characteristics may also be used.

It can thus be appreciated that the controlled liquid blending system of the present invention provides a number of advantages over prior art systems. For instance, the present invention contemplates use of a single coriolis flow meter which measures the volumetric flow, mass flow and density of the blended liquid as opposed to measuring the mass flow of the individual liquid components or streams. In addition, the present invention provides accurate measurement of the concentration of the blended product itself at a location immediately downstream of the point at which the liquid components or streams are mixed. This is in contrast to prior art systems, which involve measurement of the mass flow of the individual liquid components or streams, and then project the concentration of the mixed liquid based on the mass flow measurements of the individual streams or components. The present invention also enables the mixed product to be pressurized in line, which can result in elimination of the pressurized product holding tank utilized in the prior art. Furthermore, the present invention enables the individual liquid components, and therefore the blended liquid stream, to be processed at a variable flow rate, rather than the full production flow rate provided by prior art systems. Importantly, the present invention also allows the production of a multi-component liquid product without the use of a holding or mixing tank. The components of the final product are accurately metered and are mixed immediately downstream of the location at which the final component is introduced, and are then immediately measured to ensure the product is within specifications. If adjustments in the supply streams are required, the adjustments are made immediately and there is little product that is produced before the product is brought back into compliance with specifications.

In addition, it should be understood that the system of the present invention is not limited to use in connection with blending of two liquid streams as shown and described. In fact, the system of the present invention may be used in connection with blending of any number of liquid streams, and the measurement of characteristics of the blended streams downstream of the location at which the individual component streams are mixed may be used to provide accurate and quick adjustments in the flow of the individual streams.

Various alternatives and embodiments are contemplated as being within the scope of the following claims particularly pointing out and distinctly claiming the subject matter regarded as the invention.

I claim:

1. A blending system, comprising:
a first liquid supply arrangement for providing a first liquid component;
a second liquid supply arrangement for providing a second liquid component;
a mixing arrangement for mixing the first and second liquid components to form a mixed liquid;
a liquid parameter measuring device located downstream of the mixing arrangement and upstream of a discharge area at which the liquid is supplied to a tank or vessel, for determining a measurable parameter of the mixed liquid at a location downstream of the mixing arrangement; and
a control arrangement for controlling the first and second liquid supply arrangements in response to the mass flow measuring device.

2. The blending system of claim 1 wherein the liquid parameter measuring device is configured to measure mass flow of the mixed liquid at the location downstream of the mixing arrangement.

3. The blending system of claim 1 wherein the liquid parameter measuring device is further configured to measure volumetric flow and density of the mixed liquid at the location downstream of the mixing arrangement.

4. The blending system of claim 1 wherein the liquid parameter measuring device is a coriolis-type mass flow meter.

5. The blending system of claim 1 wherein the first liquid supply arrangement includes a syrup supply and the first liquid component is syrup used to form a soft drink, and the second liquid supply arrangement includes a water supply and the second liquid component is water.

6. The blending system of claim 5 further comprising a carbon dioxide supply system that injects carbon dioxide into the mixed liquid at a location downstream of the liquid parameter measuring device.

7. The blending system of claim 6 further comprising a pressurized holding tank, and wherein the carbonated mixed liquid is fed to the pressurized holding tank for storage.

8. The blending system of claim 6 further comprising a chiller through which the carbonated mixed liquid is passed to chill the carbonated mixed liquid and a filling system that receives the chilled carbonated mixed liquid from the chiller.

9. The blending system of claim 8 further comprising a pair of metering pumps, wherein a first metering pump controls the flow of the first liquid component from the first liquid supply arrangement and a second metering pump controls the flow of the second liquid component from the second liquid supply arrangement, and wherein the metering pumps are further operative to isolated the chilled carbonated mixed liquid from the first liquid supply arrangement and the second liquid supply arrangement to maintain pressure in the chilled carbonated mixed liquid.

10. A blending system, comprising:
a first liquid supply arrangement for providing a first liquid component;
a first volumetric flow determining device for determining the volumetric flow of the first liquid component;
a second liquid supply arrangement for providing a second liquid component;
a second volumetric flow determining device for determining the volumetric flow of the second liquid component;
a mixing arrangement for mixing the first and second liquid components to form a blended liquid;
a liquid parameter measuring device for determining a measurable parameter of the mixed liquid at a location downstream of the mixing arrangement and upstream of a discharge area at which the liquid is supplied to a tank or vessel; and
a control arrangement for controlling the first and second liquid supply arrangements in response to the liquid parameter measuring device.

11. The blending system of claim 10 wherein the liquid parameter measuring device is configured to determine a density of the mixed liquid.

12. The blending system of claim 11 wherein the liquid parameter measuring device is further configured to determine a volumetric flow and a mass flow of the mixed liquid.

13. The blending system of claim 12 wherein the liquid parameter measuring device is a coriolis-type flow meter.

14. The blending system of claim 10 further comprising a carbonation injection system configured to inject carbon dioxide into the mixed liquid, a chiller for chilling the carbonated liquid, and a filler configured to fill a number of containers with chilled carbonated liquid.

15. The blending system of claim 14 further comprising a holding tank disposed between the chiller and the filler, and configured to receive chilled carbonated liquid from the chiller and hold the chilled carbonated liquid for subsequent delivery to the filler.

16. A blending system, comprising:
a first liquid supply arrangement for providing a first liquid component;
a second liquid supply arrangement for providing a second liquid component;
a mixing arrangement for mixing the first and second liquid components to form a blended liquid;
a liquid parameter measuring device for measuring a measurable parameter of the mixed liquid at a location downstream of the mixing arrangement and upstream of a discharge area at which the liquid is supplied to a tank or vessel; and
a control arrangement for controlling the first and second liquid supply arrangements in response to the liquid parameter measuring device.

17. The blending system of claim 16 wherein the liquid parameter measuring device is further configured to determine a density and a volumetric flow of the mixed liquid.

18. The blending system of claim 17 wherein the liquid parameter measuring device is further configured to determine a mass flow of the mixed liquid.

19. The blending system of claim 18 wherein the liquid parameter measuring device is a coriolis-type flow meter.

20. The blending system of claim 16 further comprising a carbonation injection system configured to inject carbon dioxide into the mixed liquid, a chiller for chilling the carbonated liquid, and a filler configured to fill a number of containers with chilled carbonated liquid.

21. The blending system of claim 20 further comprising a holding tank disposed between the chiller and the filler, and configured to receive chilled carbonated liquid from the chiller and hold the chilled carbonated liquid for subsequent delivery to the filler.

22. A blending system comprising:
a first liquid component supply arrangement that provides a first liquid component;
a second liquid component supply arrangement that provides a second liquid component;
a mixing arrangement in fluid communication with the first and the second liquid component supply arrangements, and configured to mix the first liquid component and the second liquid component to form a mixed liquid; and
a post-mix arrangement, downstream of the mixing arrangement and absent a holding tank, that conditions the mixed liquid for subsequent deposition into at least one container.

23. The blending system of claim 22 wherein the post-mix arrangement includes a liquid parameter measuring device that measures a measurable parameter of the mixed liquid, and further comprising a controller that communicates with the first liquid component supply arrangement and the second liquid component supply arrangement to control the first and the second liquid supply arrangements.

24. The blending system of claim 23 wherein the post-mix arrangement further includes a chilling device that chills the mixed liquid and a filling device that fills the at least one container with the chilled liquid.

25. The blending system of claim 24 wherein the post-mix arrangement further includes a gas supply that injects carbon dioxide into the mixed liquid.

26. The blending system of claim 22 wherein the first liquid component is beverage syrup and the second liquid component is water.
